(19) United States
(12) Patent Application Publication
(10) Pub. No.: US 2002/0172409 A1
(43) Pub. Date: Nov. 21, 2002

(54) Displaying three-dimensional medical images

(76) Inventors: Motoaki Saito, Tokyo (JP); Kazuo Takahashi, Tokyo (JP)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/860,965

(22) Filed: May 18, 2001

(51) Int. Cl. G06K 9/00

(52) U.S. Cl. 382/132; 382/154

(57) ABSTRACT

Multiple objects having the same physical property within a subject are displayed as distinct three-dimensional images. Projection data obtained by scanning the subject with electromagnetic radiation are used to create a spatial distribution of absorption values for the subject which is displayed as an image on an image display unit. Particular spatial regions within the image are defined as objects, with each object comprising a set of voxels. A density, gradient and color for an object are determined based on properties input through the a series of control panels on the image display unit. Each object is associated with one of the control panels. A relationship between degrees of opacity and values for the voxels in an object is defined in the control panel for the object and used to determine the density. The control panels also allow one or more of the objects to be selected for display. The density, gradient and color for the objects are stored in a memory. A volume rendering process uses the memory to create the three-dimensional images.

### FIELD OF THE INVENTION

This invention relates generally to the displaying of three-dimensional medical image, and more particularly to displaying discrete images of objects having the same physical property.

### COPYRIGHT NOTICE/PERMISSION

A portion of the disclosure of this patent document may contain material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the software and data as described below and in the drawings hereto: Copyright © 1999, TeraRecon Inc., All Rights Reserved.

### BACKGROUND OF THE INVENTION

X-ray computerized axial tomography (CT) produces exact cross-sectional image data that express the physical property (electron density) of the human body. Reconstructions of three-dimensional images using multiple axial images acquired at different axial positions have been performed for some time. Helical-scan X-ray CT scanners and cone-beam X-ray CT scanners have been put to practical use recently. This has enabled more precise three-dimensional image reconstructions.

For three-dimensional display of medical images, a surface rendering method is often used that displays the interfaces between objects after extracting these interface planes from objects constituting a subject, and a volume rendering method is used that is based on a three-dimensional array of voxels having values relating to a physical property of the study subject.

In the case of the volume rendering method, anatomical regions of the subject are classified based on CT values in the three-dimensional array of the voxels that is constructed from X-ray CT slices. Therefore, one can separate spatial regions with different CT values as different objects. A spatial region with the same CT value is classified as one object, so one cannot separate a spatial region with this same CT value into different objects, even if the spatial region with this same CT value is separated geometrically. However, it is often desirable to separate a spatial region with the same CT value into two or more objects.

For example, one may want to remove the front portion of an organ to observe the inside of it so there is a need to separate the spatial region with the same CT value into two or more objects. For example, one may want to remove muscles of a front portion of extremities to observe relations of bones and muscles in these extremities so there is a need to separate the spatial region with the CT value for muscle into two or more objects.

For example, in a case of simulating joint motion, there is a need to separate a spatial region with the same CT value into two or more bones. For example, in the case of simulating a brain operation, there is a need to remove a small part of the skull with the same CT value as the rest of the skull, to open an aperture in the skull and observe inside.

When using the conventional volume rendering method, objects with different CT values can be separated from each other, but objects with same CT value cannot be separated into more than one object, even if the locations of the parts are different.

Volume rendering alone is therefore not suitable for an application that separates the spatial region with the same physical property into two or more objects, such as the simulation of an operation.

Additionally, the conventional volume rendering method requires a large amount of processing power, and reducing the processing time is very important. Therefore, because the processing time increases with the increase in the number of objects rendered, the amount of processing time required to handle a large number of objects means the conventional volume rendering method is often unsatisfactory for practical use.

Furthermore, the conventional volume rendering method permits objects with different physical properties to be separated from each other, but objects with the same physical property cannot be separated into more than one object, even if the locations of the parts are different.

There is a need to subdivide a spatial region with the same physical property into two or more objects while also reducing the processing time required to reconstruct the objects. Furthermore, there is a need to keep processing time at a minimal even if the number of objects is increased.

### SUMMARY OF THE INVENTION

Multiple objects having the same physical property within a subject are displayed as distinct three-dimensional images. Projection data obtained by scanning the subject with electromagnetic radiation are used to create a spatial distribution of absorption values for the subject which is displayed as an image on an image display unit. Particular spatial regions within the image are defined as objects, with each object comprising a set of voxels. A density, gradient and color for an object are determined based on properties input through the a series of control panels on the image display unit. Each object is associated with one of the control panels. A relationship between degrees of opacity and values for the voxels in an object is defined in the control panel for the object and used to determine the density. The control panels also allow one or more of the objects to be selected for display. The density, gradient and color for the objects are stored in a memory. A volume rendering process uses the memory to create the three-dimensional images.

In one aspect, the invention displays a part of one object with modified opacity and color by replacing a part of one object with another object where the spatial regions of the two objects overlap. In yet another aspect, the invention changes the size of an object and moves its location to change the relative position of the objects in the three-dimensional image.

Thus, a spatial region having a uniform physical property within a three-dimensional medical image can be subdivided into two or more objects that are displayed with different colors and opacities. When the number of objects increases, the volume rendering process can build the three-dimensional image quickly because all the necessary information is accumulated in the memory. Therefore, the apparatus can save processing power and produce a final image in a short processing time. Even if there are two or more objects, it is possible to display them on a single display screen, and it is possible to grasp the spatial relations of two or more objects correctly and easily.

In addition to the aspects and advantages of the present invention described in this summary, further aspects and advantages of the invention will become apparent by reference to the drawings and by reading the detailed description that follows.

### BRIEF DESCRIPTION OF THE DRAWINGS

FIG. 1 is a schematic block diagram showing a configuration of the three-dimensional medical image display apparatus according to one embodiment of the present invention.

FIG. 2 is a drawing schematically showing a panel of the invention that defines properties of each object in the subject.

FIG. 3 is a block diagram of a three-dimensional medical image display apparatus according to the present invention.

FIG. 4 is a block diagram of a data-processing unit suitable for use with the invention.

### DETAILED DESCRIPTION OF THE PREFERRED INVENTION

In the following detailed description of embodiments of the invention, reference is made to the accompanying drawings in which like references indicate similar elements, and in which is shown by way of illustration specific embodiments in which the invention may be practiced. These embodiments are described in sufficient detail to enable those skilled in the art to practice the invention, and it is to be understood that other embodiments may be utilized and that logical, mechanical, electrical, functional and other changes may be made without departing from the scope of the present invention. The following detailed description is, therefore, not to be taken in a limiting sense, and the scope of the present invention is defined only by the appended claims.

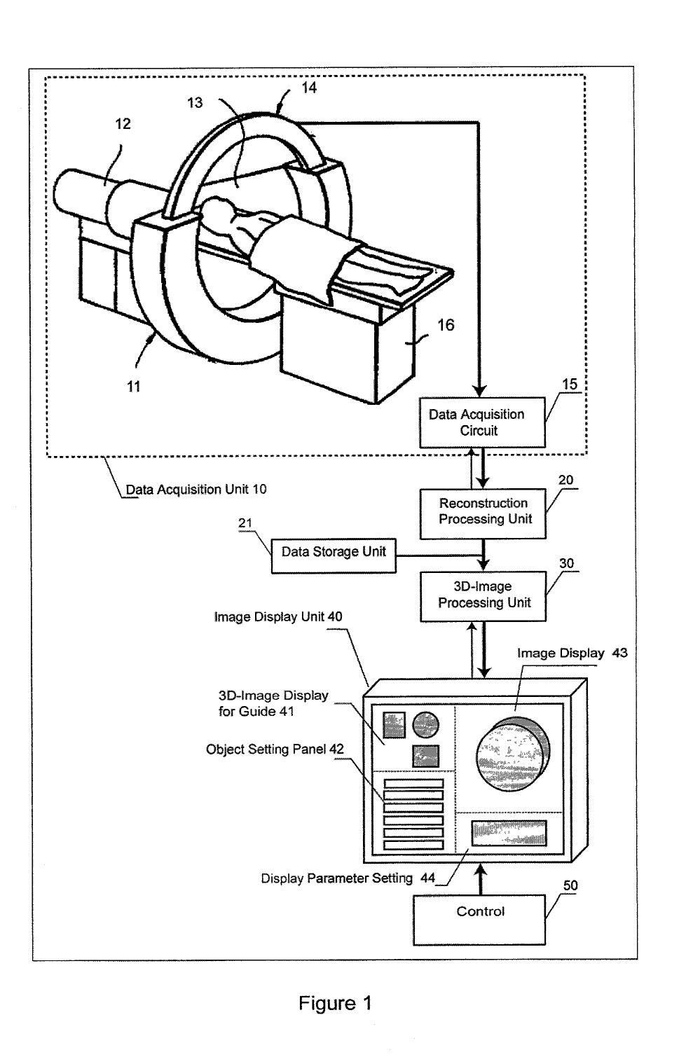

FIG. 1 is a block diagram showing on embodiment of this invention. A data acquisition apparatus 10 is an apparatus that collects projection data of a subject by electromagnetic radiation from the circumference and measures the transmitted dose. The data acquisition apparatus 10 is described herein as an X-ray computerized axial tomography (CT) scanner, such as an electron beam scanning type X-ray CT scanner, for purposes of explanation but the invention functions similarly in other apparatus such as a magnetic resonance (MR) or ultrasound apparatus and is not limited to use with X-ray CT scanners.

The apparatus 10 controls an electron beam 13 emitted from an electron gun 12 for scanning an X-ray target 11 annularly located around a subject. The X-ray beam generated by the X-ray target transmits the cross section of the subject on a bed 16, and an X-ray detector 14 intercepts the transmitted X-ray beam. A data acquisition circuit 15 converts output current of the X ray detector into digital data. By moving the bed 16, the apparatus 10 repeats the electronic beam scan, and collects projection data of two or more cross sections of the subject.

A reconstruction-processing unit 20 performs pre-processing, reconstruction processing, and post-processing of the acquired projection data, and creates an image that expresses a spatial distribution of CT values equivalent to the X-ray absorption coefficient of the subject. The reconstruction-processing unit 20 is a data-processing unit containing a processor programmed to reconstruct the projection data into image data. A data storage unit 21 stores the image data reconstructed in the reconstruction-processing unit 20. While the projection data is described as being obtained by X-ray CT equipment, it will be apparent that data can be obtained from other medical image equipment, such as magnetic resonance (MR) or Ultrasound equipment.

A three-dimensional image-processing unit 30 is a data processing unit programmed to reconstruct a three-dimensional image from the image data. The three-dimensional image-processing unit 30 carries out the reconstruction of the three-dimensional image by volume rendering the image data from the reconstruction-processing unit 20 or the image data stored in the data storage unit 21.

An image display unit 40 has an auxiliary three-dimensional image display screen 41 (labeled as “3D-Image Display for Guide” in FIG. 1); an object property setting panel 42, a three-dimensional image display screen 43, and a display-parameter setting panel 44.

The auxiliary three-dimensional image display screen 41 is used for defining spatial regions of objects. The three-dimensional image display screen 43 is used to display a three-dimensional image reconstructed by the three-dimensional image-processing unit 30.

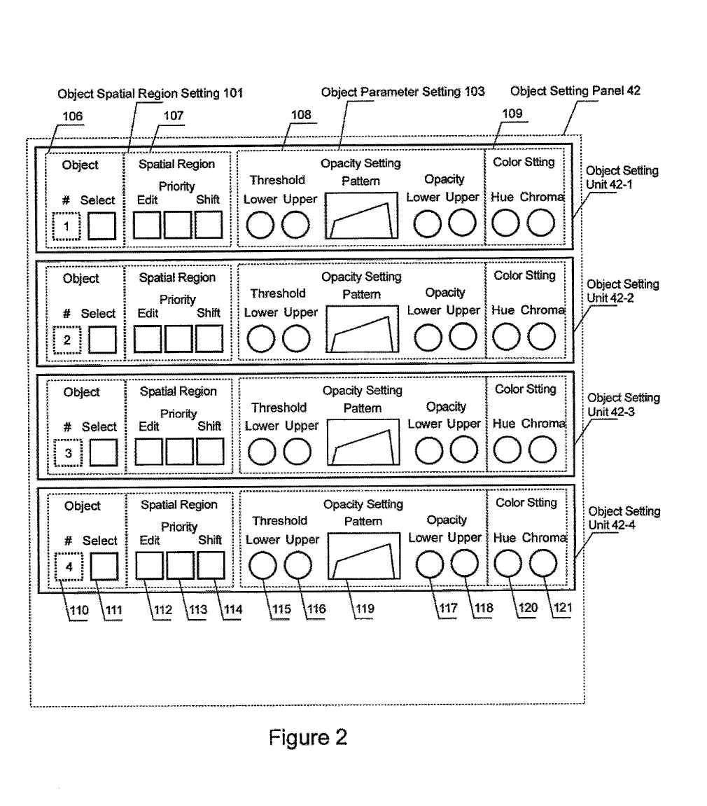

To define properties of any object, the object-property setting panel 42 has a plurality of object-setting units that include: a panel for selecting the object for display; a panel to define a spatial region of the object using the auxiliary three-dimensional display screen; a panel to define a relation between opacity and voxel-value of the object; and a panel to assign color information to the object. FIG. 2 is a drawing of the object-property setting panel 42. To define properties of objects of interest, a plurality of object-setting units 42-1, 42-2, 42-3, 42-4 etc. are provided.

Each object-setting unit is used to define properties of one object of interest. Each of the object-setting units has an object spatial-region setting section 101 and an object-parameter setting section 103. Each object spatial-region setting section 101 has an object selection panel 106 and an object spatial-region setting panel 107. Each object-parameter setting section 103 has an object-opacity setting panel 108 and an object-color setting panel 109.

Each object-selection panel 106 has a “number” display 110 that assigns a number to the object being defined in this object-setting unit. Each object-selection panel 106 has an object-selection switch 111 that is used to include the object to reconstruct a three-dimensional image. By pushing the object-selection switch 111, the object that is prepared in this object-setting unit is selected to participate in the reconstruction of a three-dimensional image.

Each object spatial-region setting panel 107 has an “edit” switch 112, a “priority” switch 113, and a “shift” switch 114. The edit switch 112 is used to edit and define a spatial-region for the object using the three-dimensional image currently displayed on the auxiliary three-dimensional image display screen 41, such as cropping or cutting planes.

The priority switch 113 is used to set the priority order of the objects in relation with other objects for reconstructing three-dimensional images. The shift switch 114 is used to set an arbitrary spatial displacement of the object when reconstructing a three-dimensional image to shift the object's location on the display. The shift switch 114 may also allow the size of the object to be expanded or reduced. For example, the shift switch 114 may consist of a wheel that increases or decreases magnification of the object on the display when not depressed and moves the object around on the display when depressed.

The object-opacity setting panel 108 has a “lower threshold” setting knob 115 and an “upper threshold” setting knob 116. The lower threshold setting knob 115 is used to define the lower limit of the CT values in the object that exists in the spatial-region defined by the object spatial-region setting panel 107. The upper threshold setting knob 116 is used to define the upper limit of the CT values in the object that exists in the spatial-region defined by the object spatial-region setting panel 107. An object consists of a set of voxels, i.e., a set of cubic units as described in detail further below, that exist in the spatial-region defined by the object spatial-region setting panel 107 and that have CT values between the lower threshold and the upper threshold.

The object-opacity setting panel 108 has an opacity “lower limit” setting knob 117 and an opacity “upper limit” setting knob 118. The opacity lower limit setting knob 117 is used to define the lower limit of the opacity values that are given to a set of voxels that have CT values between the lower threshold and the upper threshold. The opacity upper limit setting knob 118 is used to define the upper limit of the opacity values that are given to a set of voxels that have CT values between the lower threshold and the upper threshold.

A “pattern” panel 119 is used to define a function that expresses the relation between CT value and opacity value. The horizontal axis of the pattern panel 119 expresses CT value, and the vertical axis expresses the opacity value. By changing the curve of the pattern, the relation between opacity and CT value can be modified, within the lower limit and upper limit of opacity and within the lower threshold and upper threshold of CT value.

The object-color setting-panel 109 has a “hue” knob 120 and a “saturation” knob 121 (labeled “chroma” in FIG. 2). The hue knob 120 and the saturation knob 121 set color information for the object, i.e. the color of voxels that have CT values between lower threshold and upper threshold defined by switches 115 and 116, respectively, and exist in the spatial region defined in the object spatial-region setting part 101.

Using the object-setting unit 42-1, 42-2, 42-3, 42-4 etc., it is possible to set up the spatial region, range of CT values, range of opacities, and color information for each object of interest. Therefore it is possible to separate and display objects with the same physical property that exist in different spatial regions. This was difficult in the prior art of conventional volume rendering.

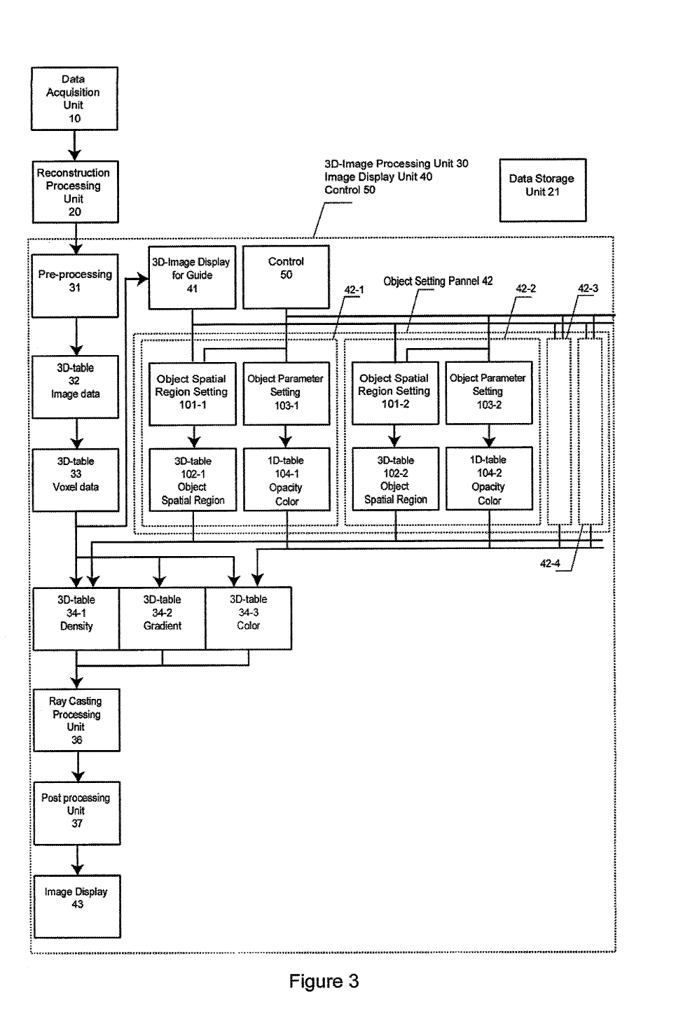

FIG. 3 is a block diagram describing the operation of the embodiment of the invention in FIG. 1 in more detail. The data acquisition apparatus 10 collects projection data of two or more cross sections of a subject. The reconstruction-processing unit 20 creates image data of the cross sections by reconstruction processing of the projection data. The image data are transmitted to the three-dimensional image-processing unit 30. A pre-processing unit 31 performs image data processing on the transmitted image data, including compensation of an effect of gantry tilt of the X-ray CT apparatus and interpolation of image data in the direction of the body axis of a subject.

The interpolated image data is stored in the three-dimensional table 32 by the preprocessing unit 31. Image data for a first plane have an origin at the upper left corner; an X-axis that increases from left to right; and a Y axis intersecting perpendicularly with X-axis that increases top down. Image data for successive planes are stacked in the Z-direction that intersects perpendicularly with X-Y plane, in the order of the cross section positions in the subject. In the X-ray CT apparatus, the values in the three-dimensional table 32 are CT values.

For example, the X-axis increases from left to right in the cross section of a subject; the Y-axis intersects perpendicularly with X-axis and increases from the upper part to the lower part in the cross section of the subject, and the Z-axis of the right-hand system intersects perpendicularly with X-Y plane. When a unit cube with a unit vector along the X-axis, a unit vector along the Y-axis, and a unit vector along the Z-axis is considered, a three-dimensional table is built by accumulating such unit cubes. The unit cube is called a voxel.

The auxiliary three-dimensional image display screen 41 is used for specifying the spatial region of the object. The auxiliary three-dimensional image display screen 41 displays a three-dimensional image reconstructed from voxel data stored in the three-dimensional table 33. Examples of such three-dimensional images are:

1) A multi-planer reformation image with an axial plane, a sagittal plane and a coronal plane;

2) an image made from stacking the cross sectional images; or

3) an image after three-dimensional processing.

The object-property setting panel 42 is used to define objects through their properties. Each of the object-setting units 42-1, 42-2, 42-3, 42-4 etc. is used to define the properties of one object of interest. In FIG. 3, only object-setting units 42-1 and 42-2 are illustrated for sake of simplicity. It will be appreciated that object-setting units 42-3 and 42-4 contain elements corresponding to those described below for object-setting units 42-1 and 42-2 and numbered accordingly. It will further appreciated that the invention is not limited to four object-setting units.

Each object-setting unit has an object spatial-region setting section 101 and an object-parameter setting section 103. Each object spatial-region setting section 101 has an object selection panel with a “number” display and a selection switch, and an object spatial-region setting panel with an “edit” switch, a “priority” switch 113, and a “shift” switch, as previously described.

Using the three-dimensional image displayed on the auxiliary three-dimensional image display screen 41 and the object spatial-region setting panel 107, the spatial-region of the object is defined. The defined spatial region is displayed on the auxiliary three-dimensional image display screen 41.

Each object-parameter setting section 103 has an object-opacity setting panel with a “lower threshold” setting knob, an “upper threshold” setting knob, an opacity “lower limit” setting knob, an opacity “upper limit” setting knob and a “pattern” panel, and an object-color setting panel with a “hue” knob and a “saturation” knob, as previously described. The range of CT values of objects, a degree of opacity of objects, and color information for objects are defined by the object-parameter setting section 103.

Each spatial region of the object defined in the object spatial-region setting panels 101-1, 101-2, 101-3, or 101-4 is mapped to the three-dimensional tables 102-1, 102-2, 102-3, or 102-4. The three-dimensional tables 102-1, 102-2, 102-3, or 102-4 have same three axes as the three-dimensional table 33. Within the spatial region for the reconstruction of the three-dimensional image, each voxel in table 102 has a value of 1.

Outside of the spatial region for the reconstruction of the three-dimensional image, each voxel in table 102 has a value of 0. If a spatial region of an object is defined by the logical product of two-dimensional regions defining the axial plane, sagittal plane, or coronal plane, the output of the object spatial-region setting panel 101-1, 101-2, 101-3, or 101-4 may be used directly to define the spatial region of the object, without using the three-dimensional tables 102-1, 102-2, 102-3, or 102-4.

Each object parameter setting panel 103-1, 103-2, 103-3, or 103-4 sets up the range of CT values, the degree of opacity and the color information for each object of interest.

This result is mapped to the one-dimensional table 104-1, 104-2, 104-3 or 104-4 in which the index is the CT value, and value 1 is the degree of opacity and value 2 is color information. Thus, each table 104 defines a relation between a CT value and a degree of opacity, and a relation between a CT value and color information.

For example, the object parameter setting panel 103-1 defines the maximum and the minimum CT value that the object of interest has in the object spatial-region setting panel 101-1, the degree of opacity that each CT value within the range has, and the display color given to the object of interest. This result is mapped to the one-dimensional table 104-1.

For the range of CT values of the object of interest defined by the object parameter setting panel 103-1, 103-2, 103-3, or 103-4, the one-dimensional tables 104-1, 104-2, 1043, or 104-4 contain the degrees of opacity corresponding to the CT values, and the color information assigned to the object of interest. For example, each one-dimensional table 104-1, 104-2, 104-3, or 104-4 holds the degree of opacity and color information within the limits of CT values for each object of interest defined in the object-parameter setting panel 103-1, 103-2, 103-3, or 103-4, and outside of the range of CT values, the opacity is 0 and there is no color information.

A three-dimensional table 34 has three axes that intersect spatially, and has voxels corresponding to voxels in the three-dimensional table 33. Value 34-1 of each voxel in the three-dimensional table 34 is a density value, value 34-2 is a derivative (gradient) along the X-axis direction, Y-axis direction, and Z-axis direction of the voxel values, and value 34-3 is a color value of the voxel.

If a voxel in the three-dimensional table 33 exists in the spatial region defined in the three-dimensional table 102-1, and it has a CT value within the limits of CT value defined in the one-dimensional table 104-1, the density value 34-1 of the voxel in the three-dimensional table 34 is obtained by multiplying the opacity in the one-dimensional table 104-1 with the CT value of the voxel in the three-dimensional table 33. If a voxel of the three-dimensional table 33 exists in the spatial region defined in the three-dimensional table 102-1, and its CT value is within the limits of CT values defined in the one-dimensional table 104-1, the color value 34-3 of the voxel in the three-dimensional table 34 is calculated from the color information in the one-dimensional table 104-1.

If a voxel of the three-dimensional table 33 exists in the spatial region defined in the three-dimensional table 102-2, and it has CT value within the limits of CT value defined in the one-dimensional table 104-2, the density value 34-1 of the voxel in the three-dimensional table 34 is obtained by multiplying the opacity in the one-dimensional table 104-2 with the CT value of the voxel in the three-dimensional table 33. If a voxel of the three-dimensional table 33 exists in the spatial region defined in the three-dimensional table 102-2, and its CT value is within the limits of CT value defined in the one-dimensional table 104-2, the color value 34-3 of the voxel in the three-dimensional table 34 is calculated from the color information in the one-dimensional table 104-2.

If the range of CT values of the object of interest defined in the object parameter setting part 103-1 overlaps with the CT value of another object of interest defined in the object parameter setting part 103-2, and the spatial region of the object of interest defined in the object spatial-region setting panel 101-1 overlaps with the spatial region of the other object of interest defined in the object spatial-region setting panel 101-2, the object having higher priority is used for the overlap region. If the priority of the object is not defined, the object having the higher number of the object-setting unit has priority.

The ray-casting processing unit 36 calculates the pixel values projected onto a screen, using density data, gradient data, and color data that are accumulated in the three-dimensional table 34. A post-processing unit 37 performs any necessary post-processing, for example, an affine conversion for geometry correction on data obtained in the ray-casting processing unit 36, and creates the image for display on the image display unit 43.

A series of typical operations to create a three-dimensional image is described next.

(1) Define Object(s)

(1.1) Define object 1, using the object setting panel 42-1.

(1.1.1) Operator selects switch 110 for object 1.

(1.1.2) Selecting switch 112, the operator defines the spatial region of object 1.

(1.1.3) Using knob 115 and knob 116, the operator defines the lower limit of the CT values and upper limit of the CT values of object 1.

(1.1.4) Using knob 117 and knob 118, the operator defines the lower limit of the opacity values and upper limit of the opacity values of object 1.

(1.1.5) Using pattern panel 119, the operator defines opacity curve of object 1.

(1.1.6) Using knob 120 and knob 121, the operator defines hue and saturation of object 1.

(1.1.7) If necessary, selecting switch 114, the operator expands or contracts the spatial region and shifts location of object 1.

(1.2) Define object 2, using the object setting panel 42-2

(1.2.1) Operator selects switch 110 for object 2.

(1.2.2) Selecting switch 112, the operator defines spatial region of the object 2.

(1.2.3) Using knob 115 and knob 116, the operator defines the lower limit of the CT values and the upper limit of the CT values of object 2.

(1.2.4) Using knob 117 and knob 118, the operator defines the lower limit of the opacity values and the upper limit of the opacity values of object 2.

(1.2.5) Using pattern panel 119, the operator defines the opacity curve of object 2.

(1.2.6) Using knob 120 and knob 121, the operator defines hue and saturation of object 2.

(1.2.7) If necessary, selecting switch 114, the operator expands or contracts the spatial region and shifts the location of object 2.

(1.3) Define object 3, using the object setting panel 42-3.

(1.3.1) Operator selects switch 110 for object 3.

(1.3.2) Selecting switch 112, the operator defines the spatial region of the object 3.

(1.3.3) Using knob 115 and knob 116, the operator defines the lower limit of the CT value and upper limit of the CT value of the object 3.

(1.3.4) Using knob 117 and knob 118, the operator defines the lower limit of the opacity values and the upper limit of the opacity values of object 3.

(1.3.5) Using pattern panel 119, the operator defines the opacity curve of object 3.

(1.3.6) Using knob 120 and knob 121, the operator defines hue and saturation of object 3.

(1.3.7) If necessary, selecting switch 114, the operator expands or contracts the spatial region and shifts the location of object 3.

(1.4) Define object 4, using the object setting panel 42-4.

(1.4.1) Operator selects switch 110 for object 4.

(1.4.2) Selecting switch 112, the operator defines the spatial region of the object 4.

(1.4.3) Using knob 115 and knob 116, the operator defines the lower limit of the CT value and upper limit of the CT value of the object 4.

(1.4.4) Using knob 117 and knob 118, the operator defines the lower limit of the opacity values and the upper limit of the opacity values of object 4.

(1.4.5) Using pattern panel 119, the operator defines the opacity curve of object 4.

(1.4.6) Using knob 120 and knob 121, the operator defines hue and saturation of object 4.

(1.4.7) If necessary, selecting switch 114, the operator expands or contracts the spatial region and shifts the location of object 4.

(2) Select object(s) for reconstruction, using the “selection” switch 111.

(2.1) Press the selection switch 111 of the object-setting panel 42-1 to include object 1. Press the selection switch 111 of the object-setting panel 42-2 to include object 2.

(2.3) Press the selection switch 111 of the object-setting panel 42-3 to include object 3.

(2.4) Press the selection switch 111 of the object-setting panel 42-4 to include object 4.

(3) Set the priority of the object, using the “priority” switch 112.

(3.1) Set the priority switch 112 of the object setting panel 42-1 to “2” for object 1.

(3.2) Set the priority switch 112 of the object setting panel 42-2 to “1” for object 2.

(4) Mapping density, gradient and color on the three-dimensional memory 34.

(4.1) For the spatial region that has value 1 in the three-dimensional memory 102-4, the three-dimensional image processing unit 30 calculates density from the CT value in the three-dimensional memory 33 and the opacity and CT value relation in the one-dimensional memory 104-4, calculates color from the CT value in the three-dimensional memory 33 and the color and CT value relation in the one-dimensional memory 104-4, and maps the results on the three-dimensional memory 34.

(4.2) For the spatial region that has value 1 in the three-dimensional memory 102-3, the image processing unit 30 calculates density from the CT value in the three-dimensional memory 33 and the opacity and CT value relation in the one-dimensional memory 104-3, calculates color from the CT value in the three-dimensional memory 33 and the color and CT value relation in the one-dimensional memory 104-3, and maps the results on the three-dimensional memory 34.

(4.3) For the spatial region that has value 1 in the three-dimensional memory 102-2, the image processing unit 30 calculates density from the CT value in the three-dimensional memory 33 and the opacity and CT value relation in the one-dimensional memory 104-2, calculates color from the CT value in the three-dimensional memory 33 and the color and CT value relation in the one-dimensional memory 104-2, and maps it on the three-dimensional memory 34.

(4.4) For the spatial region that has value 1 in the three-dimensional memory 102-1, the image processing unit 30 calculates density from the CT value in the three-dimensional memory 33 and the opacity and CT value relation in the one-dimensional memory 104-1, calculates color from the CT value in the three-dimensional memory 33 and the color and CT value relation in the one-dimensional memory 104-1, and maps the results on the three-dimensional memory 34.

(5) The ray-casting processing unit 36 calculates the value projected on a screen, using density data, gradient data, and color data that are accumulated in the three-dimensional table 34.

(6) The post-processing unit 37 performs post-processing and creates the image displayed on the image display unit 43.

The operations of one embodiment of the invention can be summarized as follows.

Scanning each voxel of the three-dimensional table 33 one by one, the invention checks the values of the objects' spatial regions in the three-dimensional-tables 102-1, 102-2, 102-3, 102-4 corresponding to the coordinates of the voxel, and the value of the opacity in the one-dimensional tables 104-1, 104-2, 104-3, 104-4 corresponding to the CT value of the voxel.

If the value of the object spatial region of the three-dimensional-table 102-1, 102-2, 102-3, 102-4 corresponding to the coordinates of the voxel is 1, and the value of the opacity of the one-dimensional table 104-1, 104-2, 104-3, 104-4 corresponding to CT value of the voxel is not 0, the voxel in the three-dimensional table 33 is mapped to the voxel in the three-dimensional table 34.

Value one 34-1 of the voxel in the three-dimensional table 34 has a density value that is taken from the CT value of the voxel of the three-dimensional table 33, and the opacity of the one-dimensional tables 104-1, 104-2, 104-3, 104-4 corresponding to the CT value of the voxel in the three-dimensional table 33. Value two 34-2 of the voxel in the three-dimensional table 34 is the gradient of the CT values that is calculated from the CT values of the voxels near the voxel in the three-dimensional table 33. Value three 34-3 of the voxel in the three-dimensional table 34 is a color value that is calculated from the color information in the one-dimensional tables 104-1, 104-2, 104-3, 104-4 corresponding to the CT value of the voxel.

The ray-casting processing unit 36 uses the density data, gradient data, and color data which are accumulated in the three-dimensional table 34 to calculate the pixel value that is projected on a display. Even if there are two or more objects, a single ray-casting process can build the three-dimensional image quickly because all the information is accumulated in the three-dimensional table 34. Therefore, the apparatus can save processing power and produce a final image in a short processing time. Even if there are two or more objects, it is possible to display them on a single display screen, and it is possible to grasp the spatial relations of two or more objects correctly and easily.

The priority switch 113 in the spatial-region setting panel 107 is used to define the spatial region of an object of interest. For example, if the spatial regions of two objects overlap, priority of the objects can be specified with the priority switch 113 in the spatial-region setting panel 107. The value of each voxel in the overlapped region in the three-dimensional table 34 has the values of the object that has higher priority.

For example, when a user displays the three-dimensional image of a skull, brain and blood vessels, he defines a new object for the skull and a part of the brain, sets the priority of the new object high, and changes the opacity of the new object freely. The user can observe the relation of skull, brain, and blood vessels in detail by this method.

For example, when a user displays a three-dimensional image of an organ, and wants to observe the inside of the organ, he wants to remove a front portion of a plane to observe a back portion of the plane in detail. By defining a new object for the front portion of the plane, and making the priority of this object higher than the priority of the whole organ and setting the opacity of the new object to zero, it is possible to remove the front portion of the organ in the three-dimensional image.

For example, if a user wants to observe the relation of muscles and bones in a lower limb, he wants to remove a front portion of a plane. By defining a new object for the front portion of the plane, and setting CT value range of the new object for muscle, and by making the priority of the object higher than the priority of the whole lower limb and setting the opacity of this object to zero, the user can remove a front portion of the muscles from the three-dimensional image of the muscles.

After expanding the region of an object that has a higher priority, it is possible to remove the expanded region from the object that has lower priority.

The invention also allows segmentation of a three-dimensional image using a CT value range setting and a color setting. Previously, if a user wanted to display a skull as an object with white color, and to display blood vessels in the cranium as an object with red color, frequently not only blood vessels but also periostea on the surface of the skull is displayed in red, because both have same CT value. In contrast, using the invention, a user specifies the skull as having the highest priority, a geometrically expanded skull as having a lower priority, and zero opacity, and the blood vessel in a cranium as having the west priority so that the periostea on the surface of a skull is not displayed. Thus, it is possible to display vividly both skull and blood vessels in a cranium, without being influenced by the depiction of periostea on the surface of a skull.

For example, a user wants to change the spatial relationship of two or more objects in the case of a surgical operation simulation. The “shift” switch 114 in the spatial-region setting panel 107, sets up the amount of movement for displaying the object. By pushing the “shift” switch 114, the amount of movement of the spatial position and orientation of the object of interest can be edited. If the voxel of the three-dimensional table 33 is mapped onto the voxel of the three-dimensional table 34, each voxel of the three-dimensional table 33 is subjected to movement, rotation, or movement and rotation, and then mapped into the three-dimensional table 34. Thus, it is possible to change the relative position of the objects in the three-dimensional image.

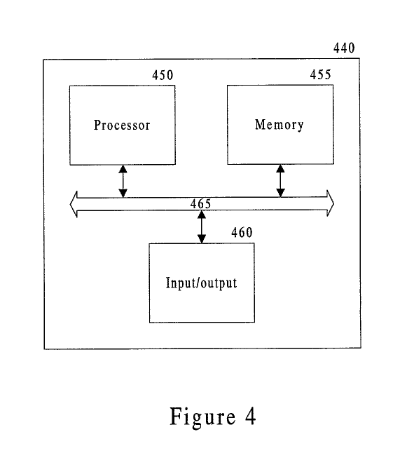

Turning now to FIG. 4, one embodiment of a computer system 400 for use with the present invention is described. The system 400, includes a processor 450, memory 455 and input/output capability 460 coupled to a system bus 465. The memory 455 is configured to store instructions which, when executed by the processor 450, perform the functions of the invention described herein. The memory 455 may also store the various tables previously described and the results of the processing of the data within those tables. Input/output 460 provides for the delivery and display of the images or portions or representations thereof. Input/output 460 also provides for access to the image data provided by other components and for user control of the operation of the invention. Further, input/output 460 encompasses various types of computer-readable media, including any type of storage device that is accessible by the processor 450. One of skill in the art will immediately recognize that the term “computer-readable medium/media” further encompasses a carrier wave that encodes a data signal.

The instructions may be written in a computer programming language or may be embodied in firmware logic. If written in a programming language conforming to a recognized standard, such instructions can be executed on a variety of hardware platforms and for interface to a variety of operating systems. In addition, the present invention is not described with reference to any particular programming language. It will be appreciated that a variety of programming languages may be used to implement the teachings of the invention as described herein. Furthermore, it is common in the art to speak of software, in one form or another (e.g., program, procedure, process, application, module, logic . . . ), as taking an action or causing a result. Such expressions are merely a shorthand way of saying that execution of the software by a computer causes the processor of the computer to perform an action or a produce a result.

The foregoing description of FIG. 4 is intended to provide an overview of computer hardware and other operating components suitable for implementing the invention, but is not intended to limit the applicable environments. It will be appreciated that the computer system 440 is one example of many possible computer systems which have different architectures. A typical computer system will usually include at least a processor, memory, and a bus coupling the memory to the processor. One of skill in the art will immediately appreciate that the invention can be practiced with other computer system configurations, including multiprocessor systems, minicomputers, mainframe computers, and the like. The invention can also be practiced in distributed computing environments where tasks are performed by remote processing devices that are linked through a communications network.

What is claimed is:

1. An apparatus for displaying three-dimensional medical images of a subject comprising:
an auxiliary display screen;
means for defining properties of one or more objects included in the subject comprising:
means for selecting an object for display;
means for defining a spatial region for an object using the auxiliary display screen;
means for defining a function representing a relation between opacity and a voxel-value for an object; and
means for assigning a color to an object;
means for mapping a voxel-density, a voxel-gradient, and a voxel-color onto a memory for each object selected for display, the voxel-density being calculated from the voxel-value and the function; and
means for volume rendering using the voxel-density, voxel-gradient and voxel-color in the memory to create a three-dimensional image for display.

2. The three-dimensional medical display apparatus according to claim 1, further comprising:
means for replacing a part of a first object with a second object by assigning the opacity and color of the second object to the part of the first object, the part of the first object being defined by where the first and second objects overlap in space.

3. The three-dimensional medical display apparatus according to claim 1, further comprising:
means for changing a size for a particular object and to move a location of the particular object with relation to other objects.

4. The three-dimensional medical display apparatus according to claim 2, further comprising:
means for changing a size for a particular object and to move a location of the particular object with relation to other objects.

5. A method for displaying three-dimensional medical images of a subject comprising:
obtaining properties for an object included in the subject, the object comprising a set of voxels and the properties comprising a selection indicator, a spatial region, color information, and a first function representing a relation between a degree of opacity and values for the set of voxels; and
if the selection indicator indicates the object is selected for display, creating a three-dimensional image of the object comprising:
calculating a density for each of the set of voxels using the first function;
calculating a gradient for each of the set of voxels based on adjacent voxels;
determining a color for each of the set of voxels;
mapping the density, gradient, and color for the set of voxels onto a memory; and
performing volume rendering on the density, gradient, and color in the memory.

6. The method according to claim 5 further comprising:
displaying a part of a first object with the opacity and color of a subset of voxels for a second object, the subset being defined by where the first and second objects overlap in space.

7. The method according to claim 6 further comprising:
determining whether to replace the part of the first object using priorities assigned to the first and second objects.

8. The method according to claim 5 further comprising:
changing a size for a particular object and moving a location of the particular object with relation to other objects.

9. The method according to claim 5 further comprising:
obtaining a second function representing a relation between the color information and values for the set of voxels, wherein the color of each of the set of voxels is determined using the second function.

10. A computer-readable medium having executable instructions for performing a method comprising:
obtaining properties for an object included in the subject, the object comprising a set of voxels and the properties comprising a s election indicator, a spatial region, color, and a first function representing a relation between a degree of opacity and values for the set of voxels; and
if the selection indicator indicates the object is selected for display, creating a three-dimensional image of the object comprising:
calculating a density for each of the set of voxels using the first function;
calculating a gradient for each of the set of voxels based on adjacent voxels;
determining a color for each of the set of voxels;
mapping the density, gradient, and color for the set of voxels onto a memory; and
performing volume rendering on the density, gradient, and color in the memory.

11. The computer-readable medium according to claim 10 having further executable instructions comprising:
displaying a part of a first object with the opacity and color of a subset of voxels for a second object, the subset being defined by where the first and second objects overlap in space.

12. The computer-readable medium according to claim 11 having further executable instructions comprising:
determining whether to replace the part of the first object using priorities assigned to the first and second objects.

13. The computer-readable medium according to claim 10 having further executable instructions comprising:
changing a size for a particular object and moving a location of the particular object with relation to other objects.

14. The computer-readable medium according to claim 10 having further executable instructions comprising:
obtaining a second function representing a relation between the color information and values for the set of voxels, wherein the color of each of the set of voxels is determined using the second function.

15. A computer system comprising:
a processor;
a memory coupled to the processor through a bus; and
an image process executed from the memory to cause the processor to map to the memory a density, gradient and a color for each of a set of voxels representing an object in a subject and to create a three-dimensional image of the object by performing volume rendering on the density, gradient, and color in the memory.

16. The computer system of claim 15, wherein the image process further causes the processor to obtain a selection indicator for the object and to only create the three-dimensional image when the selection indicator indicates that the object is selected.

17. The computer system of claim 15, wherein the image process further causes the processor to obtain a function representing relation between a degree of opacity and values for the set of voxels in the object and to calculate the density by applying the function to the set of voxels.

18. The computer system of clam 15, wherein image process further causes the processor to display a part of a first object with the opacity and color of a subset of voxels for a second object, the subset being defined by where the first and second objects overlap in space.

19. The computer system of claim 15, wherein the image process further causes the processor to determine whether to replace the part of the first object using priorities assigned to the first and second objects.

20. The computer system of claim 15, wherein the image process further causes the processor to change a size for a particular object and move a location of the particular object with relation to other objects.
